(19) United States
(12) Patent Application Publication
(10) Pub. No.: US 2014/0067478 A1
(43) Pub. Date: Mar. 6, 2014

(54) METHODS AND APPARATUS TO DYNAMICALLY ESTIMATE CONSUMER SEGMENT SALES WITH POINT-OF-SALE DATA

(71) Applicant: Michael J. Zenor, Deerfield, IL (US)

(72) Inventor: Michael J. Zenor, Deerfield, IL (US)

(21) Appl. No.: 13/602,892

(22) Filed: Sep. 4, 2012

(51) Int. Cl. G06Q 30/02

(52) U.S. Cl. 705/7.34; 705/7.33

(57) ABSTRACT

Methods and apparatus are disclosed to dynamically estimate consumer segment sales with point-of-sale data. An example method includes generating a dataset of observed category panelist trips for a segment of interest, identifying a first signal variable associated with non-panelist data for a time period of interest, calculating a trip likelihood for the segment of interest based on the first signal variable, and estimating a decomposition of purchases by segment based on the trip likelihood and the non-panelist data.

### FIELD OF THE DISCLOSURE

This disclosure relates generally to market research, and, more particularly, to methods and apparatus to dynamically estimate consumer segment sales with point-of-sale (POS) data.

### BACKGROUND

In recent years, panelist data has been used by market researchers to identify demographic information associated with purchase activity. The panelist data identifies types of consumer segments, while relatively more abundant point-of-sale (POS) data has been used by the market researchers to track sales and estimate price and promotion sensitivity. Although the POS data is relatively more abundant than the panelist data, the POS data does not include segment and/or demographic information associated with the sale information.

### BRIEF DESCRIPTION OF THE DRAWINGS

FIG. 1 is a schematic illustration of a system to dynamically track consumer segments with point-of-sale data in accordance with the teachings of this disclosure.

FIGS. 2A and 2B are Gaussian likelihood responses calculated by the example system of FIG. 1.

FIGS. 3, 5, 8 and 9 are flowcharts representative of example machine readable instructions which may be executed to dynamically track consumer segments with point-of-sale data.

FIG. 4 is an example transaction dataset generated by the example system of FIG. 1.

FIG. 6 is an example averages table generated by the example system of FIG. 1.

FIG. 7 is an example scoring table generated by the example system of FIG. 1 to decompose point of sale data in view of consumer segments.

FIG. 10 is a schematic illustration of an example processor platform that may execute the instructions of FIGS. 3, 5, 8 and 9 to implement the example systems and apparatus of FIGS. 1, 2A, 2B, 4, 6 and 7.

### DETAILED DESCRIPTION

Market researchers have traditionally relied upon panelist data and/or U.S. Census Bureau data to determine segmentation information associated with one or more locations (e.g., trading areas) of interest. Segmentation information functions to map descriptive segments of consumers (e.g. Hispanic, Price Sensitive, Impulsive Purchaser, or other descriptions that may be used to characterize groups of shoppers with similar characteristics) to one or more other purchasing categories that may indicate an affinity for certain products, geography, store, brand, etc. Thus, the segmentation information may provide, for example, an indication that a first percentage of shoppers in a market of interest are Hispanic and a second percentage of the shoppers in a market of interest are non-Hispanic, where the ethnic descriptions may correlate with particular purchasing characteristics. Armed with such segmentation information and point of sale (POS) data, market researchers may multiply the relevant (POS) data with the fractional segment value corresponding to the demographic segment of interest to determine a decomposition (decomp) of sales of product(s) by segment. For example, POS data includes detailed information associated with sales in each monitored store. Such POS data may include an accurate quantity of products (e.g., which may be referred to by their associated universal product codes (UPCs)) sold per unit of time (e.g., each day, week, etc.), a price for which each UPC was sold and/or whether one or more promotions were present at the store. The mathematical product of total UPC sales and the segment percentage of the corresponding location of interest (e.g., a market, a store, a region, a town, a city, a nation, etc.) yields a value indicative of how many units of each of a set of UPCs in the corresponding location are purchased by shoppers associated with each segment.

While the mathematical product of UPCs and segment location (e.g., trading area) factors may yield an indication of UPC demand per segment-type, such analysis is static in nature as segment information associated with particular shoppers may be updated infrequently. For example, U.S. Census Bureau data is collected approximately once every decade. Such data does not allow the market researcher to appreciate UPC purchase behavior of segments that may behave differently during shorter time periods (e.g., yearly trading area changes, monthly trading area changes, etc.) or under the influence of environmental or market factors that change more rapidly. Any changes that may occur from week to week in the trading area are not reflected in a proportional factor scaling approach. Additionally, reporting UPC sales in a manner proportionate to the location of interest may result in substantial errors when UPC preferences vary among segments. An example store having a 70% non-Hispanic demographic and a 30% Hispanic demographic would employ corresponding UPC sales proportionate to factors of 0.7 and 0.3. However, products typically consumed by a Hispanic segment (e.g., Goya®) may be incorrectly associated with a substantially larger group of non-Hispanic consumers in such example diverse environments (e.g., 0.7 (the non-Hispanic demographic value)) would be multiplied by the UPCs associated with Goya® products sold at the store and, therefore, attributed to a Polish demographic/segment). In other words, the decomposition of the data does not take into account different purchasing behaviors of different population/demographic segments.

On the other hand, panelist data includes segmentation information that is not present within POS data, but in some circumstances the panelist data quantity is too low to provide statistically significant coverage of how segments purchase UPCs. Panelist data may be provided by any number of sources, including Nielsen® Homescan® data, which can be used to track a number of demographic segments and purchasing related segments. Households that make up panels are associated with segments and the data collected from the corresponding households can be used to capture market behaviors of the household member(s) associated with particular segments. While panelist data includes thorough demographic information, some panelist data lacks a sufficient degree of coverage to obtain detailed granular data regarding UPC purchases. For example, in relatively large metropolitan areas (e.g., Chicago), several thousand panelists may be used to generate panelist data regarding UPC purchases and to associate those purchases with segment information. However, the number of candidate UPCs that each panelist could purchase greatly outnumbers available panelists, which may lead to inaccuracies and/or lack coverage for granular data about which segments purchase which UPCs for a given trading area.

A candidate approach at anchoring an adjustment or estimate of UPC purchases associated with a particular segment includes Bayesian statistical techniques. Generally speaking, a Bayesian approach employs one or more “priors” (e.g., information about a value, an expectation, etc.) to generate a likelihood function which acts as a prediction of how that value will change under the influence of an external effect (sometimes referred to herein as a “signal variable.”). As additional data is received and processed, a more accurate prediction will occur. However, while panelist data includes ample segmentation information, panelist data may not be voluminous enough to accurately reflect market-level behavior. On the other hand, while POS data is voluminous and readily available, the POS data is devoid of segmentation information.

Example methods, systems, apparatus and articles of manufacture disclosed herein bridge the volume of data gap between segmentation information and POS data to dynamically decompose observed aggregated POS data among demographic segments. Additionally, because areas of commercial activity are typically not static, example methods, systems, apparatus and articles of manufacture disclosed herein consider changing proportions of segment behavior based on one or more readily available signal variables (sometimes referred to herein as condition variables), as described in further detail below.

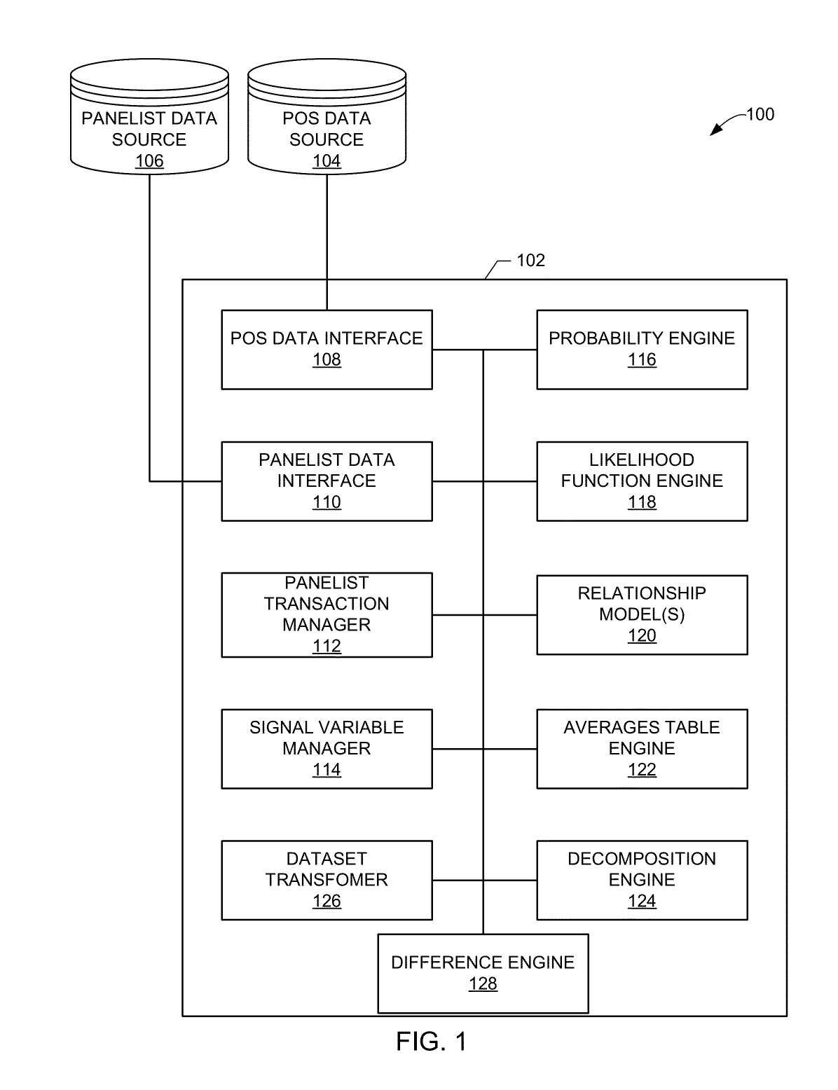

FIG. 1 is a schematic illustration of a system 100 to dynamically combine consumer segments with point-of-sale (POS) data. In the illustrated example of FIG. 1, the system 100 includes a segment estimator 102 communicatively connected to a POS data source 104 and a panelist data source 106. The example POS data source 104 may include aggregated scanner data from on-site POS checkout scanners or from consumer loyalty card or similar devices for obtained purchase information and the example panelist data source 106 may include aggregated panelist data from Homescan® panelists and/or other panelist sources. An example POS data interface 108 is communicatively connected to the example POS data source 104 and an example panelist data interface 110 is communicatively connected to the example panelist data source 106. The example system 100 of FIG. 1 also includes a panelist transaction manager 112, a signal variable manager 114, a probability engine 116, a likelihood function engine 118, a relationship model engine 120, an average table engine 122, a decomposition engine 124, a dataset transformer 126 and a difference engine 128.

In operation, the example panelist transaction manager 112 invokes the example panelist data interface 110 to obtain panelist data from the example panelist data source 106. Obtained panelist data is used by the example panelist transaction manager 112 to create one or more datasets of observed category trips for one or more segments of interest. As used herein, a trip refers to a single visit to a store/retailer by a consumer. As also used herein, segments and/or segment information includes geo-demographic information and/or other information relating to purchase behavior that may be associated with one or more households, such as segments defined by Nielsen PRIZM®. Example segments include social group segments classified by affluence (e.g., low, medium, high) and by urbanization (e.g., Urban, 2^{nd} city, Suburban, Town and Country, etc.). Other example segments include lifestage group segments based on age and/or the presence of children (e.g., Younger Years, Family Life, Mature Years, etc.). Other examples of segmentation include behavioral (Heavy vs. Light Half, Brand Loyal vs. Switchers vs. Competitive Brand Loyal, etc.) and attitudinal segments (variety seekers, bargain hunters, etc.) insofar as such segmentation can be assigned to one or more panelists.

The example signal variable manager 114 of FIG. 1 invokes the example POS data interface 108 to obtain any number of datasets of POS data. As described above, POS data may include, but is not limited to aggregated check-out scanned data that identifies each purchased UPC, a date of purchase, a time of purchase and whether one or more promotions was/were associated with the UPC purchase event(s). The example signal variable manager 114 examines the retrieved and/or otherwise received POS data to identify one or more signal variables associated with the UPC purchase event(s). Signal variables (also referred to as condition variables) include readily available information associated with the POS data, which may be dynamic from one time period to a different time period. Example signal variables include the presence of aggregate product sales, promotional activity, traffic congestion, temperature, or other variables that may be used to represent store-week patterns that may be associated with the presence of one or more consumer segments. For example, a signal variable of temperature may be associated with a presence of an older consumer segment in a particular store near a seasonal retirement community.

In some examples, the signal variables are not initially associated with the POS data and are appended to the POS data by the example signal variable manager 114. For example, POS data typically includes UPC sale events accompanied by a date/time stamp, a store location (e.g., address, zip code, lat/long, etc.) and/or a purchase price. Weather information, such as environmental temperature data near the point of sale has not previously been included in POS data cultivated by the example POS data source 104. However, global records of date and/or time stamped temperature are readily available for many geographic regions (e.g., trading areas). The example signal variable manager 114 appends at least one signal variable type and associated value(s) to the POS data to allow a trading area signature to be identified in a dynamic manner. While examples disclosed herein include temperature as a signal variable, example methods, systems, apparatus and/or articles of manufacture disclosed herein are not limited thereto. Alternate and/or additional signal variable types (e.g., weather related, non-weather related, traffic related, etc.) may be employed, without limitation. In some examples, one or more signal variable types change in a dynamic manner from one period to another time period, thereby exhibiting a signature of one or more trading areas.

The example probability engine 116 of FIG. 1 calculates and/or otherwise estimates a prior probability of segment behavior to be used with one or more likelihood functions for each segment of interest. Based on the signal variable(s), the example likelihood function engine 118 generates a distribution for each segment. While example likelihood functions disclosed herein are of a Gaussian shape, the example likelihood function engine 118 is not limited to Gaussian (e.g., normal) distribution analysis. The likelihood calculation performed by the example likelihood function engine 118 of FIG. 1 is based on an example likelihood equation shown below as example Equation 1.

$${L}_{s} = \frac{1}{\sqrt{2 π {σ}^{2}}} {e}^{[ \frac{- \frac{1}{2} {( x - {μ}_{s} )}^{2}}{{σ}_{s}^{2}} ]} . \qquad Equation 1$$

In example Equation 1, L represents a likelihood value (a trip likelihood which represents the likelihood that an individual associated with a particular segment (s) will make a trip to a store while experiencing a particular signal variable x), s represents a segment of interest, x represents a signal variable value, and μlₛ represents a mean of the signal values for a variable associated with a dataset of interest. While example Equation 1 includes a single signal variable of interest, it may be modified to represent any number of observations and/or any number of signal variables may be employed and applied to a multivariate form of the likelihood function (as described in further detail below), such as the example multivariate likelihood of Equation 2.

$${L}_{s} = {[ 2 π ]}^{( - \frac{n}{2} )} {\vert {\sum }_{s}^{ } • \vert}^{- \frac{1}{2}} exp [ - \frac{1}{2} {( x - {μ}_{s} )}^{′} {\sum }_{s}^{- 1} ( x - {μ}_{s} ) ] . \qquad Equation 2$$

In example Equation 2, L represents a likelihood value, s represents a segment of interest, x represents a vector of observations each element of which is associated with a particular one of a plurality of signal variables, μₛ represents a vector of means for a plurality of signal variables, and Σₛ represents a covariance matrix over the signal variables, in which |Σₛ| represents the determinant of the covariance matrix. While example methods, apparatus, systems and/or articles of manufacture disclosed herein discuss a single signal variable for purposes of simplicity, two or more signal variables may be used to identify a pattern and/or signature for a given location during one or more time periods (e.g., a store week). As described in further detail below, some signal variable values may exhibit correlations therebetween, which may introduce computational error and complication. To transfer the signal variables into an uncorrelated space, one or more transformations using principle components techniques (e.g., factor analysis) may be performed by the example dataset transformer 126 as a mathematical convenience.

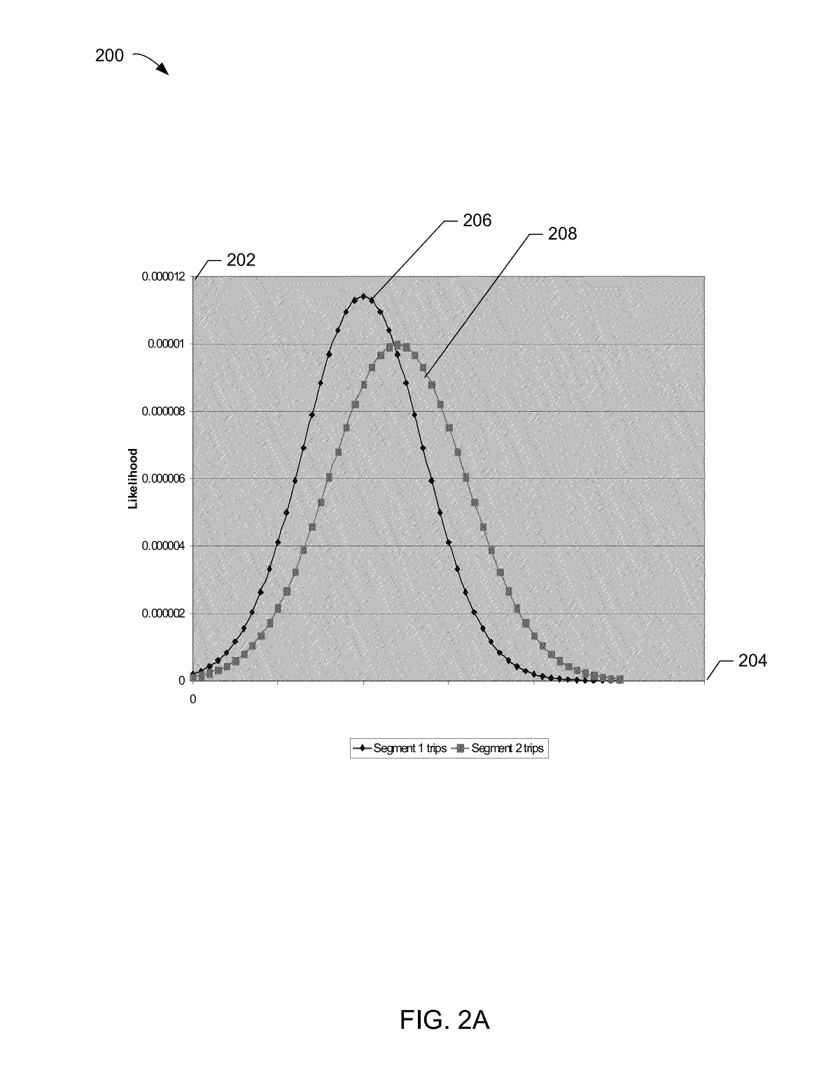

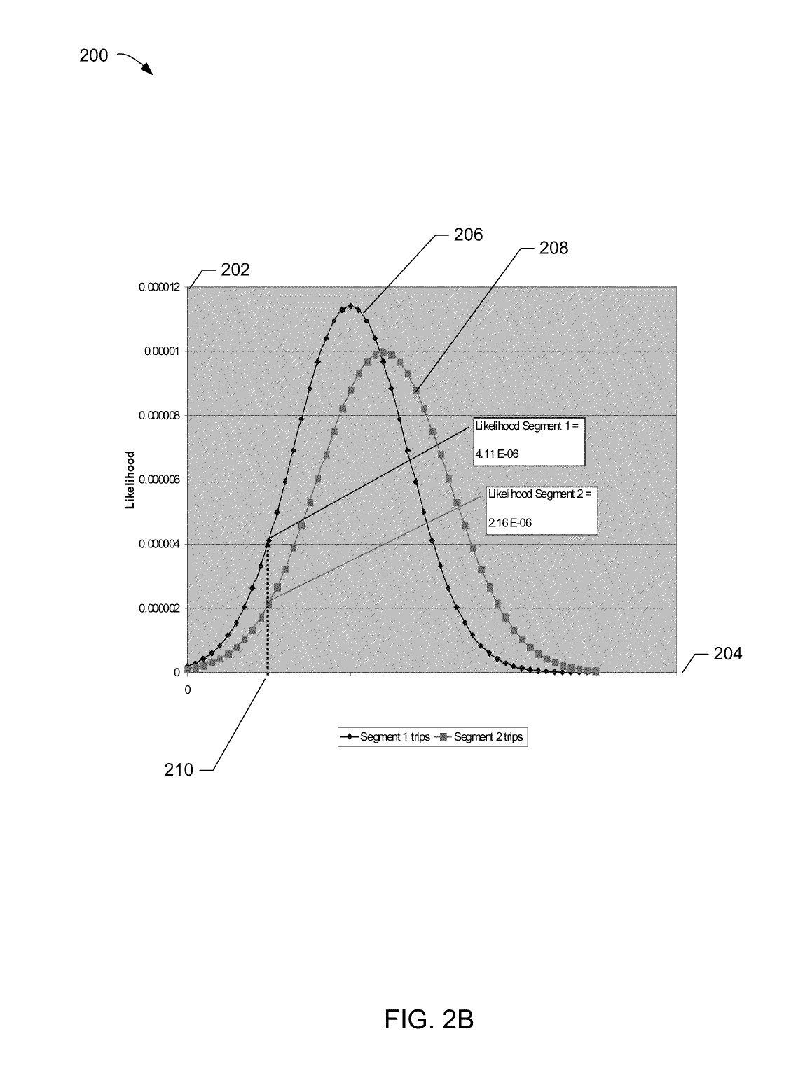

In the illustrated example of FIGS. 2A-2B, trip likelihood plots 200 include a trip likelihood vertical axis 202 and a signal variable horizontal axis 204. The example plots 200 of FIGS. 2A-2B include an example first segment trip likelihood distribution 206 and an example second segment trip likelihood distribution 208. In the illustrated example of FIGS. 2A-2B, each segment (206, 208) exhibits purchase behavior under differing levels of the signal variable 204 value(s). The example first segment trip likelihood distribution 206 is left shifted with respect to the example second segment trip likelihood distribution 208, indicating a relative difference in the likelihood that segment members will make a trip to a retailer (e.g., retailer, merchant, wholesaler, etc.) based on the value of the signal variable.

To predict a store week (or other period of interest), the example likelihood function engine 118 receives and/or otherwise selects a signal variables of interest. Continuing with the example signal variable type of temperature, when a temperature value of interest is identified, a corresponding likelihood of trip occurrence is determined, as shown in FIG. 2B. FIG. 2B includes the same trip likelihood vertical axis 202, signal variable horizontal axis 204, first segment trip likelihood distribution 206 and second segment trip likelihood distribution 208 as illustrated in FIG. 2A. In the illustrated example of FIG. 2B, a signal variable value of interest 210 is selected and/or otherwise identified. The intersection of the value of interest 210 indicates that members of the first segment distribution 206 are more likely to take a trip to a store for the given signal variable value 210 than are members of the second segment distribution 208.

The example relationship model engine 120 employs the estimated and/or otherwise calculated prior and the estimated likelihoods for each segment of interest with one or more relationship models to derive a posterior estimate of mix of trips in a store week (or other period of interest). As described above, any type of relational model may be employed, including one or more models employing a Bayesian method/techniques. Generally speaking, Bayesian techniques anchor an adjustment with an expectation of a particular variable and employ available data to adjust the expectation and thereby predict a future value for an estimated variable. Example Equation 3 illustrates a Bayesian approach to obtain a posterior estimate (i.e. a conditional probability of the likelihood of an event occurring based on the observations and the signal variable) of a mix of trips for a time period of interest.

$$π ( s \vert x ) = \frac{ L ( x \vert s ) p ( s )}{{\sum }_{{s}^{′}}^{ } L ( x \vert {s}^{′} ) p ( {s}^{′} )} . \qquad Equation 3$$

In example Equation 3, π represents the posterior estimate of the probability of a segment s making a trip under the influence of the signal variable x, s represents a segment of interest, x represents a signal variable value, L represents a likelihood, and p represents a corresponding prior.

Before using the calculated posteriors, the example average table engine 122 generates an averages table to be used during brand decomposition of POS data to illustrate activities during an average trip, as described in further detail below. Generally speaking, conditions associated with panelist data and readily available signal variables allow for dynamic assessment of segment sales (purchases made by a particular segment) of one or more retailer locations (e.g., trading areas) in a particular time period. Although the panelist data provides segment information and facilitates a determination of a likelihood of a trip per segment based on the signal variable(s), the POS data is employed to boost the coverage inherently lacking in panelist data, thereby allowing one or more models (e.g., the Bayesian model of Equation 3) to generate more accurate estimates of segment sales. The example decomposition engine 124 applies the calculated posteriors to average sales of each segment for each brand (e.g., UPC) of interest, as described in further detail below. In other words, rather than apply a relational modeling technique directly to UPC sales data derived from one or more panelist data sources, which may result in a low panelist sample size, example methods, systems, apparatus and/or articles of manufacture disclosed herein first identify a likelihood of a trip by segment using panelist data joined with the relatively abundant POS data as influenced by corresponding signal variable(s). In a subsequent phase, examples disclosed herein adjust one or more trip estimates based on priors and estimate trip-level product (e.g., UPC) purchase information. A percentage of trip mix estimates and segment trip average purchases allow calculation of aggregate sales for each segment of interest.

While an example manner of implementing the system 100 to dynamically estimate consumer segment sales with point-of-sale data has been illustrated in FIG. 1, one or more of the elements, processes and/or devices illustrated in FIG. 1 may be combined, divided, re-arranged, omitted, eliminated and/or implemented in other ways. Further, the example segment estimator 102, the example POS data source 104, the example panelist data source 106, the example POS data interface 108, the example panelist data interface 110, the example panelist transaction manager 112, the example signal variable manager 114, the example probability engine 116, the example likelihood function engine 118, the example relationship model engine 120, the example averages table engine 122, the example decomposition engine 124, the example dataset transformer 126 and/or the example difference engine 128 of FIG. 1 may be implemented by hardware, software, firmware and/or any combination of hardware, software and/or firmware. Thus, for example, any of the example segment estimator 102, the example POS data source 104, the example panelist data source 106, the example POS data interface 108, the example panelist data interface 110, the example panelist transaction manager 112, the example signal variable manager 114, the example probability engine 116, the example likelihood function engine 118, the example relationship model engine 120, the example averages table engine 122, the example decomposition engine 124, the example dataset transformer 126 and/or the example difference engine 128 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example segment estimator 102, the example POS data source 104, the example panelist data source 106, the example POS data interface 108, the example panelist data interface 110, the example panelist transaction manager 112, the example signal variable manager 114, the example probability engine 116, the example likelihood function engine 118, the example relationship model engine 120, the example averages table engine 122, the example decomposition engine 124, the example dataset transformer 126 and/or the example difference engine 128 of FIG. 1 is hereby expressly defined to include a tangible computer readable storage medium such as a memory, DVD, CD, Blu-ray, etc. storing the software and/or firmware. Further still, the example system 100 of FIG. 1 may include one or more elements, processes and/or devices in addition to, or instead of, those illustrated in FIG. 1 and/or may include more than one of any or all of the illustrated elements, processes and devices.

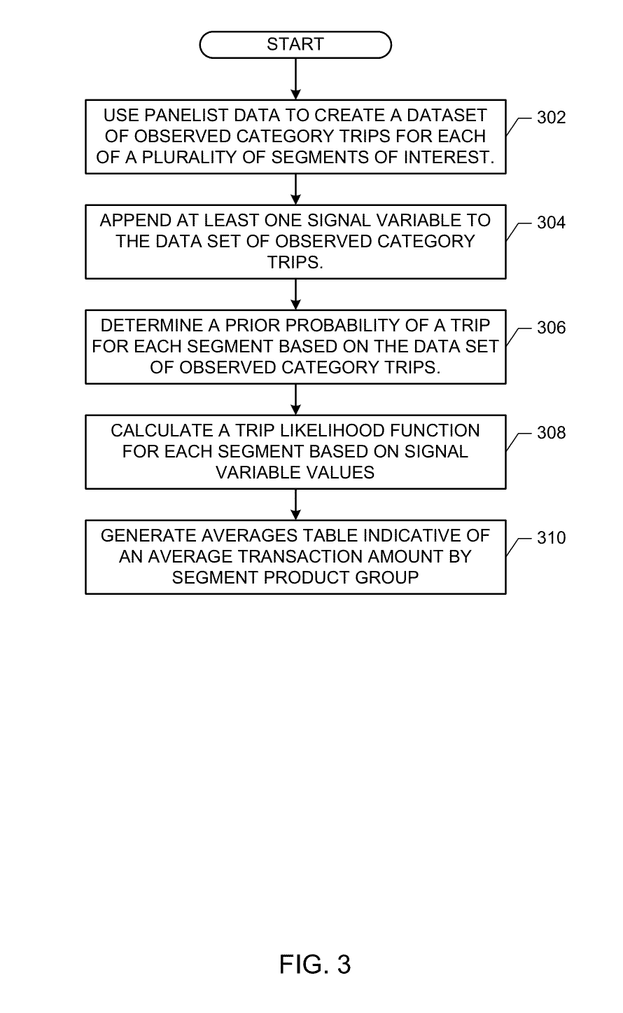

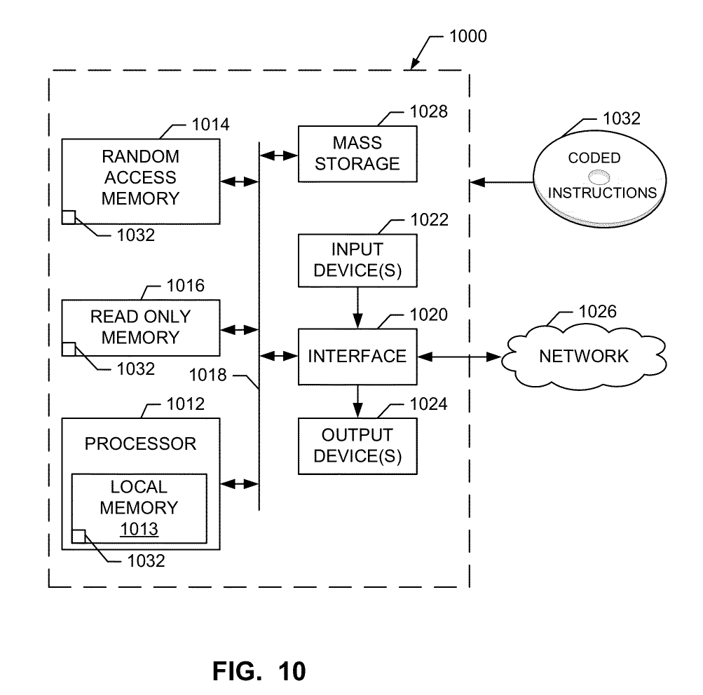

Flowcharts representative of example machine readable instructions for implementing the system 100 of FIG. 1 are shown in FIGS. 3, 5, 8 and 9. In this example, the machine readable instructions comprise a program for execution by a processor such as the processor 1012 shown in the example computer 1000 discussed below in connection with FIG. 10. The program may be embodied in software stored on a tangible computer readable storage medium such as a CD-ROM, a floppy disk, a hard drive, a digital versatile disk (DVD), a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowcharts illustrated in FIGS. 3, 5, 8 and 9, many other methods of implementing the example system 100 to manage marketing forecasting activity may alternatively be used. For example, the order of execution of the blocks may be changed, and/or some of the blocks described may be changed, eliminated, or combined.

As mentioned above, the example processes of FIGS. 3, 5, 8 and 9 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage and to exclude propagating signals. Additionally or alternatively, the example processes of FIGS. 3, 5, 8 and 9 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable storage and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

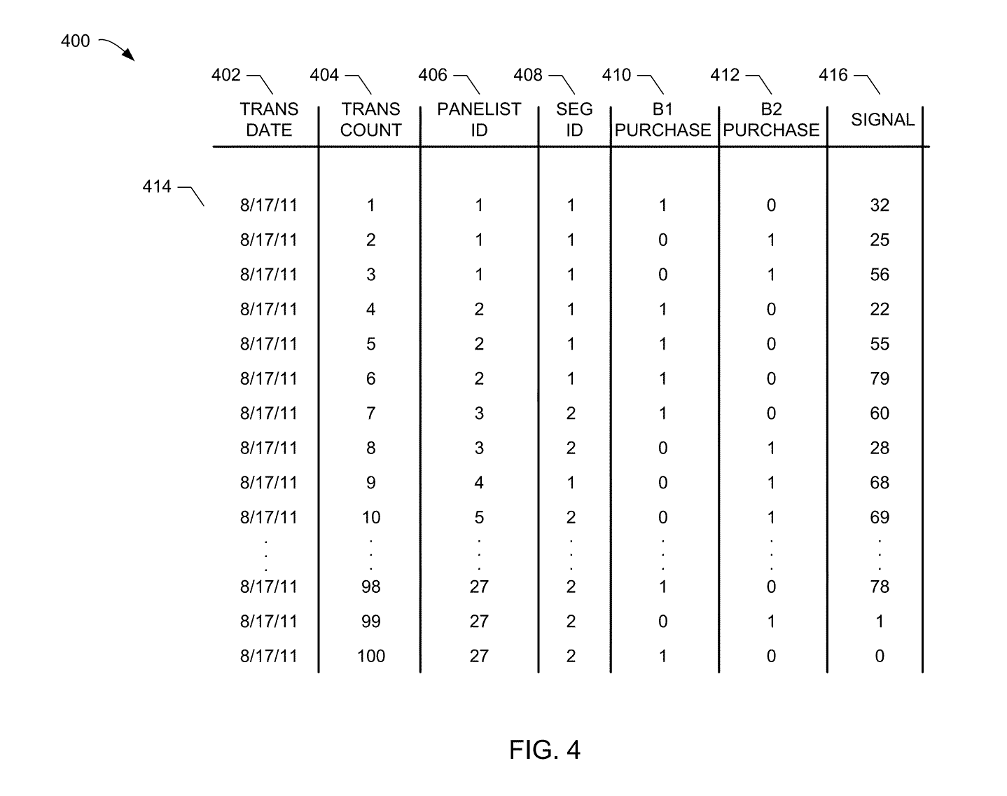

The program 300 of FIG. 3 begins at block 302 where the example transaction manager 112 creates one or more datasets of observed category trips by panelists within one or more segments of interest. In particular, the example transaction manager 112 invokes the example panelist data interface 110 to obtain panelist data from the example panelist data source 106. An example dataset 400 is shown in FIG. 4, which includes a transaction date column 402, a transaction count column 404, a panelist identifier (ID) column 406, a segment column 408, a purchase instance of brand “1” column 410 and a purchase instance of brand “2” column 412. An example first row 414 indicates that on Aug. 17, 2011 a first transaction occurred in which a first panelist associated with a first segment purchased a product associated with brand “1”. Although the example brand “1” column 410 and brand “2” column 412 include integer counts of purchase instances, example methods, apparatus, systems and/or articles of manufacture may consider currency values.

The example signal variable manager 114 invokes the example POS data interface 108 to obtain POS data associated with a date of interest so that, in part, one or more valid signal variable types may be identified (block 304). As described above, signal variables may include static or dynamic information associated with the trading area in which the POS data is associated. Signal variable types may include incremental sales information (e.g., indicative of one or more promotions occurring associated with the date of interest), weather conditions (e.g., temperature), and/or localized activities (e.g., baseball games, weekday rush hour volume, etc.). The example signal variable manager 114 appends one or more signal variables to the panelist dataset, such as an example first signal variable 416 of the example panelist dataset 400 of FIG. 4.

In the illustrated example of FIG. 4, the first signal variable 416 type is temperature, having values in degrees Fahrenheit. As described above, while some POS data includes one or more types of signal variable(s) (e.g., the existence and/or type of promotional activity, store size, number of employees, etc.), other types of POS data do not include candidate signal variable types that may be employed with example methods, apparatus, systems and/or articles of manufacture disclosed herein. In some examples, external data may be identified, retrieved, and/or otherwise provided to the signal variable manager 114, such as temperature data associated with a trading area of interest. In other examples, the segment estimator 102 identifies and/or otherwise communicates with one or more external data sources to obtain candidate signal variable values associated with the POS data (e.g., aggregate sales patterns, trading area demographics, presence of competitors, weather records, temperature, cloud conditions, traffic conditions, promotional activity, power outages, Internet service provider availability, etc.). Generally speaking, the signal variable types may include data indicative of the conditions occurring at the time of POS purchase activity.

The example probability engine 116 determines, calculates and/or otherwise estimates a prior probability (sometimes referred to herein as a prior) of segment trip presence (block 306). In some examples, prior may be calculated based on one or more marginal probability features of the dataset. In other examples, the prior may be estimated based on expectations. For example, if 60 observations existed for a first segment, and 40 observations existed for a second segment, and no other information were available to define one or more expectations of the observations, then a 60/40 factor (e.g., 0.60 and 0.40) could be used for a first iteration of the priors for the dataset. The example likelihood function engine 118 calculates trip likelihood values (e.g., distribution profiles) for each segment of interest based on the one or more signal values (block 308). As described above in view of example Equations 1 and 2, trip likelihood values depend on, in part, the average (mean), the variance, a number of observations. The result of computing example Equation 1 may yield profiles similar to those illustrated in FIGS. 2A and 2B for Gaussian distribution types. However, example methods, apparatus, systems and/or articles of manufacture disclosed herein are not limited to Gaussian distribution types. The example likelihood function engine 118 may identify candidate predictions for a store week (or other time series associated with the dataset) for a signal variable value of interest, such as is shown in the illustrated example of FIG. 2B.

While the available panelist data is not capable of being used directly to ascertain the conditional probability of events after relevant evidence is taken into account (e.g., after panelist UPCs are received), the POS data associated with retailers includes sample sizes large enough to produce granular data, but it still lacks a nexus to bridge the gap between insight (segmentation information) and coverage (adequate sample size volume). Rather than join UPC sales information from panelist data directly to POS data, example methods, apparatus, systems and/or articles of manufacture disclosed herein calculate posteriors based on the calculated likelihoods and priors as described in further detail below. Additionally, the calculated posteriors are applied to the POS data in view of the signal variables (i.e., trading area signatures) to score and/or otherwise identify segment decompositions in view of the actual UPCs purchased by shoppers.

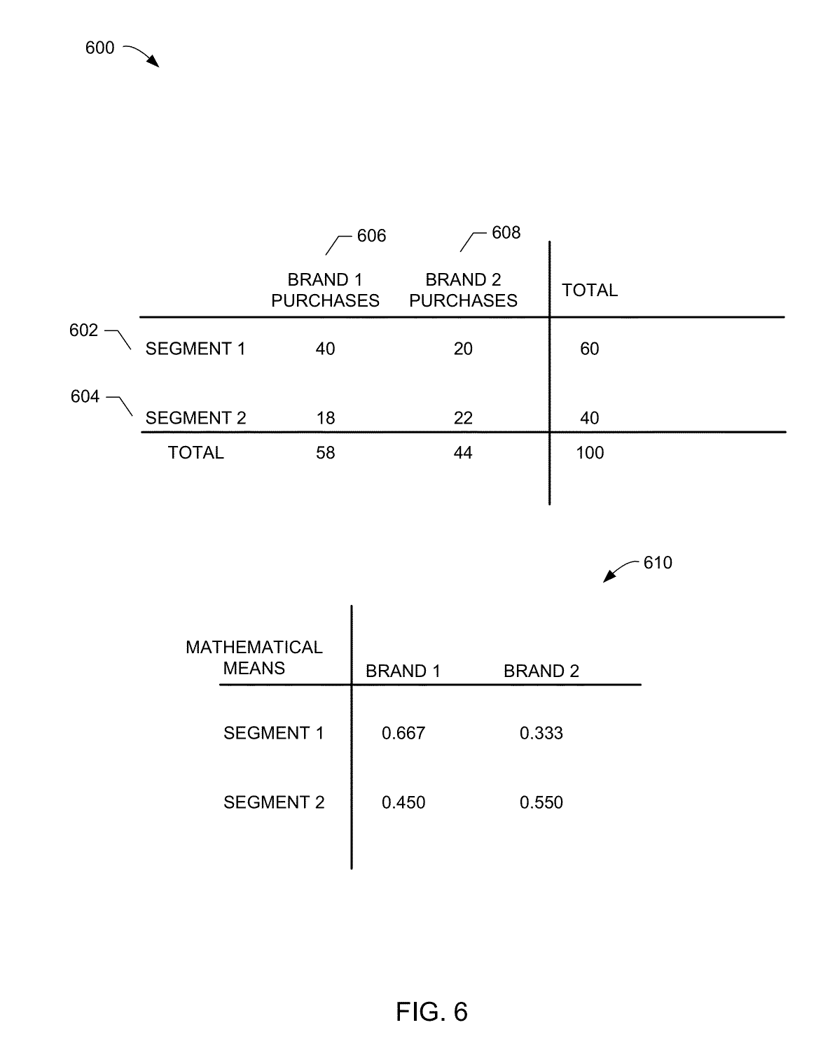

The example averages table engine 122 generates an averages table indicative of segment members to on an average trip (block 310). Turning to FIG. 6, an example averages table 600 continues the above example scenario of two segments and two different brands of interest (e.g., two different UPCs). In the illustrated example of FIG. 6, the table 600 includes a first segment of interest 602, a second segment of interest 604, a first brand of interest 606 and a second brand of interest 608. The panelist data is aggregated in the example averages table 600 to identify that members of segment 1 purchased 40 units of the first brand and 20 units of the second brand for a total of 60 units purchased. Additionally, members of segment 2 purchased 18 units of the first brand and 22 units of the second brand for a total of 40 units purchased. Corresponding totals for the first and second brands are illustrated in the example averages table 600, as are average values for each intersection of segments and brands 610. The example averages table engine 122 calculates an average value for each segment/brand combination 610 by dividing purchases of each brand by the total number of purchases for the whole segment of interest. For example, the average value for the first segment and first brand is calculated by dividing 40 units by the total of 60 units for all of the segments of interest (e.g., two segments of the example scenario of FIG. 6).

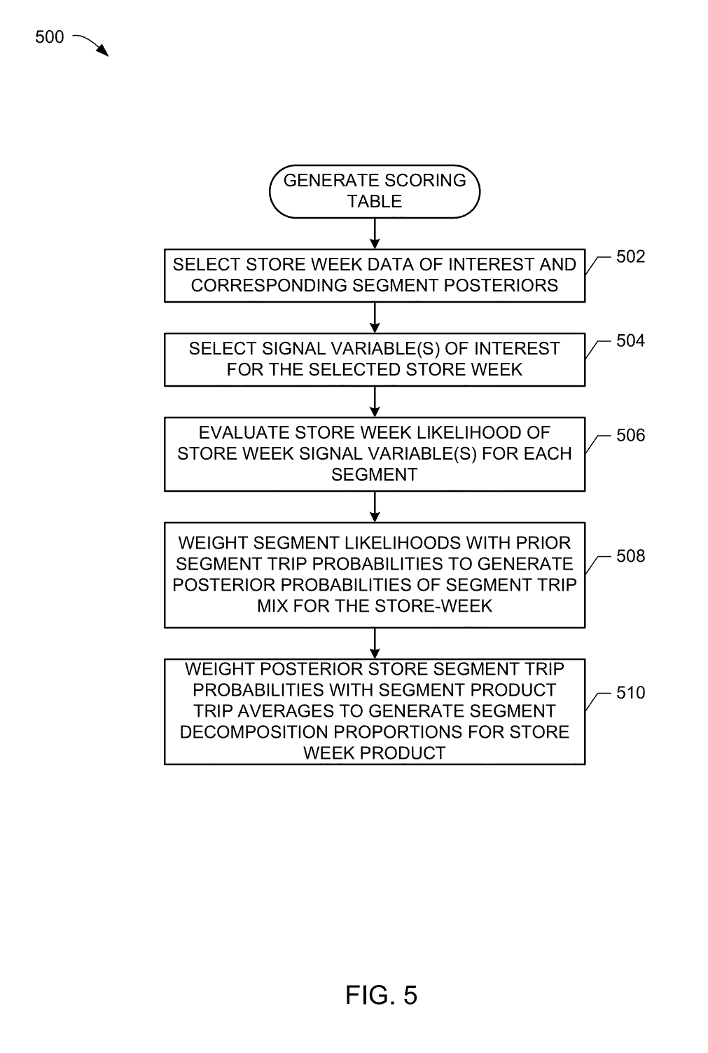

The program 500 of FIG. 5 begins at block 502 to begin generating a scoring table to determine final decompositions for each segment of interest and the one or more brands purchased by participants of that segment. The example decomposition engine 124 invokes the example POS data interface 108 to select and/or otherwise identify a store week (and corresponding data) of interest (block 502). In view of selected signal variable(s) of interest for the store-week (block 504), the example likelihood function engine 118 evaluates likelihood values (block 506), as described in further detail below. Segment likelihoods are weighted with prior segment trip probabilities to generate posterior probabilities of segment trip mix for a corresponding store week (block 508). To generate segment decomposition proportions for store week products, the example decomposition engine 124 weights the posterior store-segment trip probabilities with segment product trip averages (block 510).

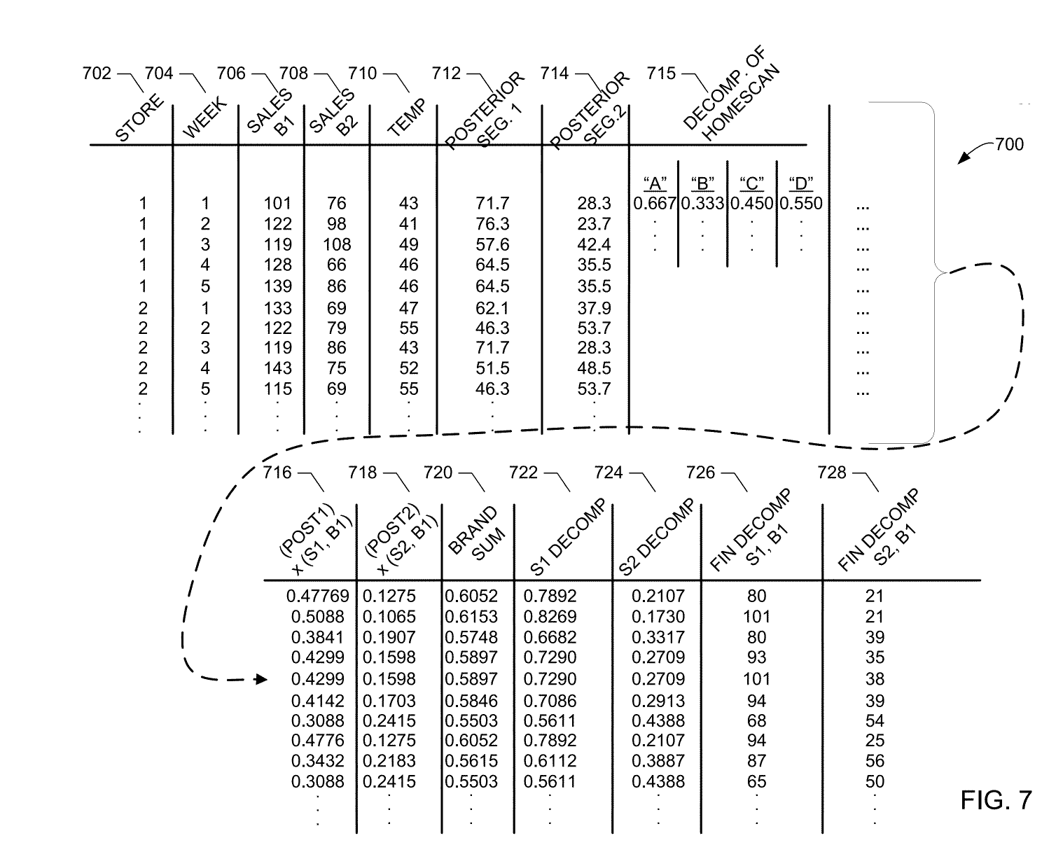

Turning to FIG. 7, an example scoring table 700 includes POS data by time period, corresponding posterior values and averages table 600 information to calculate a final decomposition for each segment and brand. In the illustrated example of FIG. 7, the scoring table 700 includes a store column of interest 702 to identify a particular store associated with decomposition information, a week column 704 to identify a time period associated with decomposition information, a sales column for a first brand 706, a sales column for a second brand 708, and a signal variable column 710 (e.g., temperature in this example). The example scoring table 700 also includes a corresponding first segment posterior column 712 to reflect a percentage of trips in a corresponding store-week for the first segment, and a second segment posterior column 714 to reflect a percentage of trips in a corresponding store-week for the second segment, and corresponding average table data 715 from the example averages table 600 of FIG. 6. The example average table data 715 includes four (4) sub-columns “A,” “B,” “C,” and “D” to reflect decompositions related to two example segments and two example brands, as shown in FIG. 6. While the aforementioned example includes two brands and segments, example methods, apparatus, systems and/or articles of manufacture disclosed herein are not limited thereto, and are disclosed in this manner for ease of explanation. Example sub-column “A” reflects an average spending amount associated with consumers in the first example segment on the first example brand of interest, sub-column “B” reflects an average spending amount associated with consumers in the first example segment on the second example brand of interest, sub-column “C” reflects an average spending amount associated with consumers in the second example segment on the first example brand of interest, and sub-column “D” reflects an average spending amount associated with consumers in the second example segment on the second example brand of interest.

The example decomposition engine 124 identifies a decomposition of a brand, which may be accomplished by multiplying a segment posterior by an average trip value of a segment of interest for a brand of interest. Continuing with the example, the scoring table 700 includes a first posterior average product column associated with the first segment and first brand of interest 716 and a second posterior average product column 715 associated with the second segment and the first brand of interest 718. In the event additional segments of interest for the brand of interest exist additional decompositions of segments may be identified. Otherwise, the example decomposition engine 124 sums brand value(s) for all segments of interest, as shown by an example brand sum column 720.

The example decomposition engine 124 determines a segment of interest decomposition based on a ratio of the posterior of a segment to a sum of all segments, which is shown on the example scoring table 700 as a first segment decomposition 722. In the event additional segments of interest exist, the example decomposition engine 124 selects a next segment posterior corresponding to the other segment of interest. In the illustrated examples disclosed herein, two segments of interest are considered, the second of which includes a second segment decomposition 724.

To determine a corresponding final segment decomposition associated with the first brand of interest, the example decomposition engine 124 calculates a ratio of the corresponding segment decomposition to the actual POS sales data for the brand of interest. As described above, the example sales column for the first brand 706 is derived from actual POS data that may be used in the ratio calculation. One or more similar computational approaches may be employed for any number of segments and/or brands of interest. In the illustrated example of FIG. 7, a final segment decomposition for the first segment of interest and first brand of interest is shown in column 726, and a final segment decomposition for the second segment of interest and first brand of interest is shown in column 728.

Accordingly, because POS volumes change from time-period to time-period (e.g., week to week), and because the associated signal variable(s) (e.g., temperature, presence of promotion, etc.) also change over time, the trip likelihood calculations disclosed above allow a dynamic analysis of market behavior in contrast to the traditional static analysis associated with, for example, U.S. Census Bureau data. Determining a percentage of trips by available segments provides a large sample size to satisfy statistical significance requirements not typically found in some panelist data. While greater volumes of panelist data may be cultivated for each location of interest (e.g., trading area(s)) to represent one or more segments of interest, such efforts are expensive. Further, such efforts may still fall short of obtaining sufficient data associated with each category of interest, brand of interest and/or individual UPCs that may be purchased within the location of interest. Instead, example methods, apparatus, systems and/or articles of manufacture disclosed herein identify a likelihood of trips by segment (e.g., a percent likelihood) that is influenced by relatively voluminous POS data and associated signal variable(s). Subsequent application of Bayesian techniques and/or other technique(s) (e.g., logit models, probit models, etc.) with panelist data (e.g., Nielsen® Homescan® data) facilitates one or more adjustments based on prior trip estimates by segment and allows a purchases per trip by the one or more segments of interest.

While example methods, apparatus, systems and/or articles of manufacture disclosed above include a single condition variable when calculating trip likelihoods, any number of condition variables may be applied in multivariate form (e.g., example Equation 2). Datasets having multiple condition variables may be both computationally intensive and exhibit circumstances of correlation that may affect computational accuracy. Accordingly, multivariate datasets may be transformed into uncorrelated space to improve computational accuracy and reduce a candidate number of condition variables for computation, such as computation of likelihood functions in the multivariate space. For example, because correlation between some variables (e.g., a temperature may indicate something about humidity, and vice versa) causes computational problems, differences (e.g., z-scores) may be computed in transformed space. Transforming variables (e.g., by way of principal components application) maintains information associated with each variable, but removes undesirable correlation effects therebetween. Additionally, calculating likelihoods in a transformed space reduces computational burdens (improves computational simplicity) by, in part, removing values associated with σ, which simplify to a value of approximately 1.

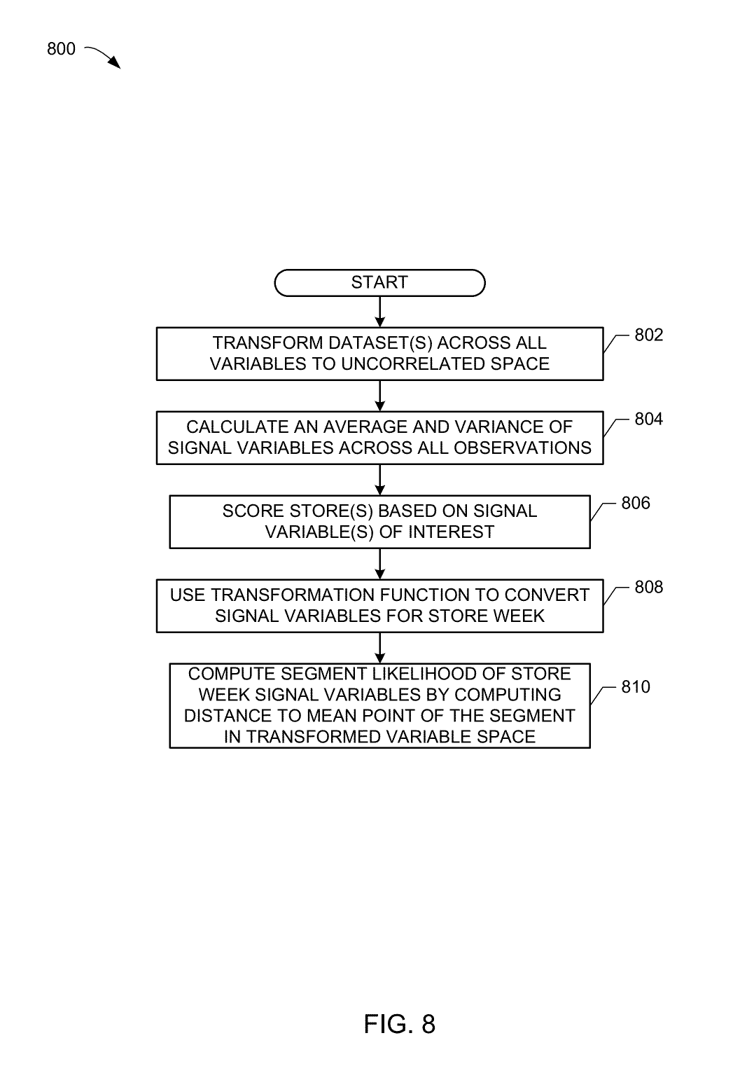

In the illustrated example of FIG. 8, a program 800 calculates trip likelihood values of a multivariate dataset, and begins at block 802 where the dataset transformer 126 transforms one or more multivariate datasets into uncorrelated space. In some examples, a transformation function is employed and is retained and/or otherwise saved for later reference when converting data back for store-week analysis. The example dataset transformer 126 calculates an average and variance of the transformed signal variables within each segment (block 804). The variance value for all observations may be calculated by the example difference engine 128 and a difference (e.g., a z-score) may be calculated for each data point in the dataset based on an overall average of available signal variable values.

When scoring an example store, the example signal variable manager 114 selects one or more signal variables of interest for a store week (or other time period of interest) (block 806). The example difference engine 128 may calculate a difference (e.g., a z-score) value based on the selected signal variable value and an average value of all other available signal variable values.

The example difference value may be based on an observed signal value of interest for a location (e.g., trading area) for a time period of interest, such as a temperature associated with POS data in the location of interest. While difference values (e.g., z-scores) may be calculated in example non-transformed application(s), one or more issues related to correlated values may be abated by transforming variables into uncorrelated space by way of, for example, principal components application(s) and/or transformations. As described above, calculations performed in uncorrelated transformed space substantially reduce computational burdens. The example difference engine 128 calculates an average difference (e.g., z-score) value for each available segment. Signal variables are converted for the store week using the retained transformation function (block 808), and the example likelihood function engine 118 computes segment likelihood values of store week signal variables by computing distance to average points of the segment in transformed variable space (block 810).

While the example program 800 of FIG. 8 illustrates an example manner of calculating trip likelihoods in a multivariate environment, in some circumstances the resulting likelihoods are not adequately reflected by and/or otherwise fit within a likelihood model, such as the example Equation 2 above. For example, some stores in one or more locations (e.g., trading areas) exhibit POS data that resides outside typical expected boundaries, such as relatively isolated stores in sparse locations and/or having signal variable values relatively far from typical stores (e.g. −10 degrees below zero). One or more stores that exhibit such POS data are sometimes referred to as “outlier stores.” In such example circumstances, resulting likelihood calculations may exhibit relatively large and/or otherwise disproportionate swings in response to small changes in signal variable values at such outlier stores.

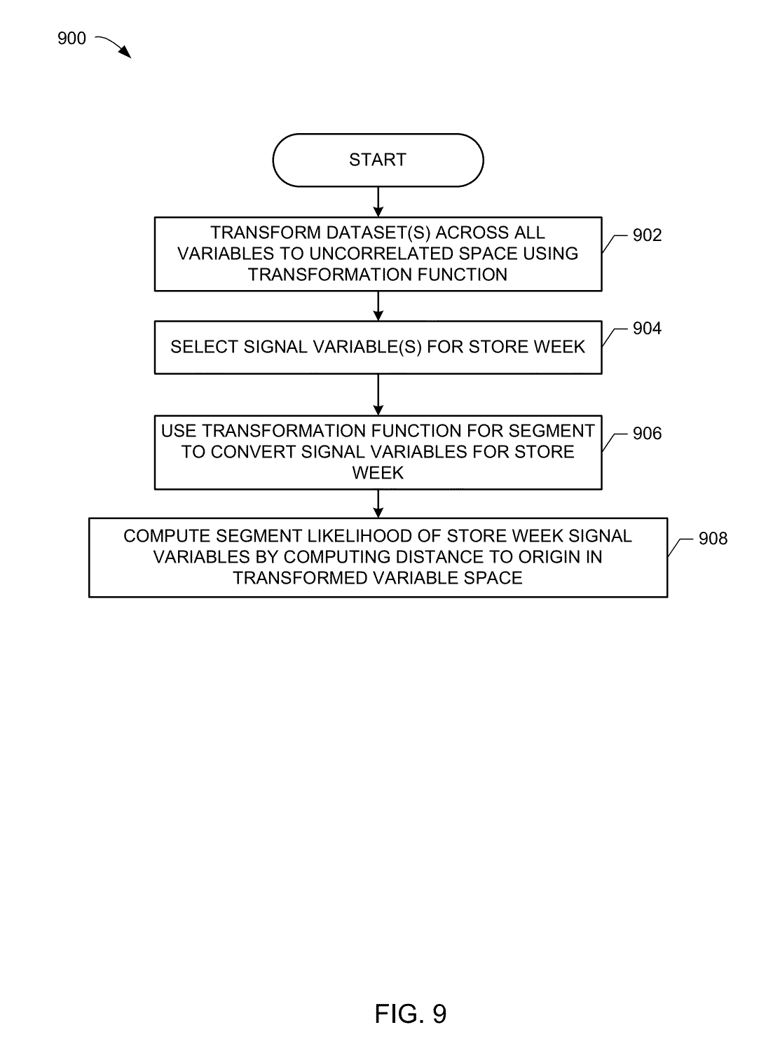

In the illustrated example of FIG. 9, a program 900 calculates trip likelihood values of a multivariate dataset in an alternate manner that may reduce the incidence of errors occurring in view of outlier stores. The example program 900 of FIG. 9 begins at block 902, where the example dataset transformer 126 transforms a multivariate dataset into uncorrelated space (that is a space in which the “off-axis” elements of the covariance matrix are zero) using a transformation function by segment. Each transformation function for each corresponding segment is retained and/or otherwise saved. The example dataset transformer 126 identifies each available segment of interest and calculates an average of signal variable values using POS data associated only with the identified segment of interest. A corresponding variance value for data associated with the segment of interest is calculated by the example difference engine 128, and the example signal variable manager 114 determines whether additional segments are available in the dataset. If so, the example signal variable manager 114 identifies a next sub-dataset of the dataset that is associated with another segment of interest.

If the dataset does not contain additional segments of interest, the example difference engine 128 calculates difference values for each observation (e.g. each signal variable value) in the dataset for one segment of interest based on the localized average for signal variable values related to that segment. Unlike the example program 800 of FIG. 8, in which each observation difference (e.g., z-score) value is calculated based on an overall average of all available signal variable values in all available segments, the example program 900 of FIG. 9 separates difference (e.g., z-score) calculations on a segment-by-segment basis. In the event additional segments of interest are available, the example signal variable manager 114 identifies another available segment of interest in the dataset.

If the dataset does not contain additional segments of interest for which a difference value (e.g., a z-score) is to be calculated, then a store may be scored by selecting a signal variable of interest associated with a store week (block 904). Based on the signal variable value (e.g., a temperature value associated with POS data), the example difference engine 128 calculates a difference value for the store based on the average of difference values (e.g., z-scores) of only the segment of interest. Unlike the example program 800 of FIG. 8, in which a single store difference value is calculated independently of a number of available segments, the example program 900 of FIG. 9 separates such calculations on a segment-by-segment basis.

If the dataset contains additional segments of interest, the example signal variable manager 114 identifies another localized average for the next segment. The transformation function for each corresponding segment is employed to convert signal variables for the store week (block 906). The example likelihood function engine 118 computes segment likelihood values of store week signal variables by computing distances to origins in transformed variable space (block 908). Corresponding likelihood values track expected model fit in a manner better than when segment POS data is aggregated together, particularly in circumstances where POS data is associated with one or more outlier stores.

FIG. 10 is a block diagram of an example processor platform 1000 capable of executing the instructions of FIGS. 3, 5, 8 and 9 to implement the system 100 of FIG. 1. The processor platform 1000 can be, for example, a server, a personal computer, an Internet appliance, or any other type of computing device.

The system 1000 of the instant example includes a processor 1012. For example, the processor 1012 can be implemented by one or more microprocessors or controllers from any desired family or manufacturer.

The processor 1012 includes a local memory 1013 (e.g., a cache) and is in communication with a main memory including a volatile memory 1014 and a non-volatile memory 1016 via a bus 1018. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 also includes an interface circuit 1020. The interface circuit 1020 may be implemented by any type of interface standard, such as an Ethernet interface, a universal serial bus (USB), and/or a PCI express interface.

One or more input devices 1022 are connected to the interface circuit 1020. The input device(s) 1022 permit a user to enter data and commands into the processor 1012. The input device(s) can be implemented by, for example, a keyboard, a mouse, a touchscreen, a track-pad, a trackball, isopoint and/or a voice recognition system.

One or more output devices 1024 are also connected to the interface circuit 1020. The output devices 1024 can be implemented, for example, by display devices (e.g., a liquid crystal display, a cathode ray tube display (CRT), a printer and/or speakers). The interface circuit 1020, thus, typically includes a graphics driver card.

The interface circuit 1020 also includes a communication device such as a modem or network interface card to facilitate exchange of data with external computers via a network 1026 (e.g., an Ethernet connection, a digital subscriber line (DSL), a telephone line, coaxial cable, a cellular telephone system, etc.).

The processor platform 1000 also includes one or more mass storage devices 1028 for storing software and data. Examples of such mass storage devices 1028 include floppy disk drives, hard drive disks, compact disk drives and digital versatile disk (DVD) drives.

The coded instructions 1032 of FIGS. 3, 5, 8 and 9 may be stored in the mass storage device 1028, in the volatile memory 1014, in the non-volatile memory 1016, and/or on a removable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to estimate segment purchases, comprising:
generating a dataset of observed category panelist trips for a segment of interest;
identifying a first signal variable associated with non-panelist data for a time period of interest;
calculating a trip likelihood for the segment of interest based on the first signal variable; and
estimating a decomposition of purchases by segment based on the trip likelihood and the non-panelist data.

2. A method as defined in claim 1, wherein the non-panelist data comprises point-of-sale (POS) data.

3. A method as defined in claim 2, wherein the POS data comprises retail product scanner data.

4. A method as defined in claim 1, further comprising calculating a posterior for a first brand of interest based on the trip likelihood, the posterior to proportionally scale the non-panelist data for the segment of interest.

5. A method as defined in claim 1, wherein estimating comprises applying a Bayesian analysis to calculate a posterior based on one or more prior estimates.

6. A method as defined in claim 1, wherein the time period of interest comprises a store-week.

7. A method as defined in claim 1, further comprising identifying a second signal variable associated with a matching time period of interest to generate a signature of a trading area of interest.

8. A method as defined in claim 1, wherein the first signal variable comprises at least one of promotion data, incremental sales data, baseline sales data, temperature data or trading area characteristic data.

9. A method as defined in claim 1, wherein the trip likelihood is calculated based on a Gaussian model.

10. A method as defined in claim 1, further comprising applying a multivariate likelihood model to calculate a trip likelihood for a plurality of signal variables of interest.

11. A method as defined in claim 10, further comprising:
calculating an average signal variable value for each one of a plurality of segments of interest;
calculating a z-score for each data point based on the average signal variable value associated with each corresponding segment from the plurality of segments of interest;
calculating an average z-score for each segment of interest based on a store signal variable value; and
calculating the trip likelihood based on the store signal variable value and the average z-score for one of the plurality of segments of interest.

12. A method as defined in claim 11, wherein the store signal variable comprises a temperature value during a store-week of interest.

13. An apparatus to estimate segment purchases, comprising:
a panelist data interface to generate a dataset of observed category panelist trips for a segment of interest;
a signal variable manager to identify a first signal variable associated with non-panelist data for a time period of interest;
a likelihood function engine to calculate a trip likelihood for the segment of interest based on the first signal variable; and
a decomposition engine to estimate a decomposition of purchases by segment based on the trip likelihood and the non-panelist data.

14. An apparatus as defined in claim 13, wherein the non-panelist data comprises point-of-sale (POS) data.

15. An apparatus as defined in claim 14, wherein the POS data comprises retail product scanner data.

16. An apparatus as defined in claim 13 further comprising a probability engine to calculate a posterior for a first brand of interest based on the trip likelihood, the posterior to proportionally scale the non-panelist data for the segment of interest.

17. An apparatus as defined in claim 13, wherein the probability engine employs a Bayesian model to calculate a posterior based on one or more prior estimates.

18. An apparatus as defined in claim 13, wherein the signal variable manager identifies a second signal variable associated with a matching time period of interest to generate a signature of a trading area of interest.

19. An apparatus as defined in claim 13, further comprising a probability engine to apply a Gaussian model to calculate the trip likelihood.

20. A tangible machine readable storage medium comprising instructions stored thereon that, when executed, cause a machine to, at least:
generate a dataset of observed category panelist trips for a segment of interest;
identify a first signal variable associated with non-panelist data for a time period of interest;
calculate a trip likelihood for the segment of interest based on the first signal variable; and
estimate a decomposition of purchases by segment based on the trip likelihood and the non-panelist data.

21. A machine readable storage medium as defined in claim 20, wherein the instructions, when executed, cause the machine to calculate a posterior for a first brand of interest based on the trip likelihood, the posterior to proportionally scale the non-panelist data for the segment of interest.

22. A machine readable storage medium as defined in claim 20, wherein the instructions, when executed, cause the machine to apply a Bayesian analysis to calculate a posterior based on one or more prior estimates.

23. A machine readable storage medium as defined in claim 20, wherein the instructions, when executed, cause the machine to identify a second signal variable associated with a matching time period of interest to generate a signature of a trading area of interest.

24. A machine readable storage medium as defined in claim 20, wherein the instructions, when executed, cause the machine to apply a multivariate likelihood model to calculate a trip likelihood for a plurality of signal variables of interest.

25. A machine readable storage medium as defined in claim 24, wherein the instructions, when executed, cause the machine to:
calculate an average signal variable value for each one of a plurality of segments of interest;
calculate a z-score for each data point based on the average signal variable value associated with each corresponding segment from the plurality of segments of interest;
calculate an average z-score for each segment of interest based on a store signal variable value; and
calculate the trip likelihood based on the store signal variable value and the average z-score for one of the plurality of segments of interest.

26. A method to reduce likelihood calculation errors in a multivariate dataset, comprising:
transforming the multivariate dataset from a correlated space to an uncorrelated space;
identifying a plurality of segments associated with the dataset in the uncorrelated space;
calculating an average of signal variable values associated with each one of the plurality of segments;
calculating difference values for the signal variable values for each one of the plurality of segments; and
calculating a segment likelihood based on one of the signal variable values and the difference values for each segment of the plurality of segments.

27. A method as defined in claim 26, wherein calculating difference values comprises calculating z-scores.
